(19) United States
(12) Patent Application Publication
(10) Pub. No.: US 2005/0118465 A1
(43) Pub. Date: Jun. 2, 2005

(54) Multiple voltages DC battery power supply system

(75) Inventor: Yuriy Dubinin, Hamtramck, MI (US)

Correspondence Address: Mr. Yuriy Dubinin;doob LLC, 2212 Yemans Street, Hamtramck, MI, 48212-3245, US

(73) Assignee: doob LLC, Hamtramck, MI (US)

(21) Appl. No.: 10/982,623

(22) Filed: Nov. 6, 2004

Related U.S. Application Data
(60) Provisional application No. 60/526,255, filed on Dec. 2, 2003.

(51) Int. Cl. H01M 16/00; B60L 11/18

(52) U.S. Cl. 429/9; 429/149; 180/65.3; 180/65.8

(57) ABSTRACT

A multiple voltage battery power supply system for operating a plurality of electrical vehicle loads at select voltage output levels is provided. The battery power supply system generally comprises at least two power blocks, each power block providing a voltage output for operating electrical vehicle loads. The at least two electrical power blocks are cascaded in series to provide a plurality of voltage output levels for powering vehicle loads at various rated voltages. Each power block independently maintains a substantially constant voltage, while the series combination of each power block also maintains a substantially constant voltage output across selected groups of blocks.

This application claims the benefit of U.S. provisional application Ser. No. 60/526,255 filed Dec. 2, 2003.

### BACKGROUND OF THE INVENTION

1. Field of the Invention

One aspect of the present invention relates generally to a multiple voltages DC electric power battery power supply system for a vehicle.

2. Background Art

Most engine driven vehicles utilize an internal combustion engine as the primary power source for propelling a vehicle. However, numerous modules and devices for the vehicle as well as the engine require electrical power. Typically, a rechargeable battery is provided with the vehicle as a basic power supply. The battery power supply system provides power for starting the vehicle engine and power for operating certain electrical loads when the vehicle is not running. The battery is recharged to maintain power by an alternator coupled to and driven by the engine when the vehicle is running. Concurrently, the alternator also provides power to the vehicle electrical loads.

With the advent of electronics in today's modern vehicle, the amount of electrical loads which require power has significantly increased. Moreover, many of the various electrical loads generally operate more efficiently at higher voltages. For example, many military vehicles, heavy trucks, and buses utilize 24-volt battery power supply systems. Such systems require half the current than standard 12 volt battery power supply systems to produce the same power output. The result is a significant reduction in power loss. However, numerous vehicle electrical loads still operate more effectively from a standard 12-volt battery power supply system.

Various systems have been proposed that provide a dual voltage output to maintain a 12-volt supply for certain accessories and a 24-volt supply for operating other selected electrical loads. One such system utilizes a single 12-volt battery for supplying power to certain 12-volt electrical loads and a single 24-volt battery for supplying power to 24-volt electrical loads. A single alternator and complex electronics are implemented to switch back and forth between a 12-volt and a 24-volt load.

Another dual voltage system utilizes two 12-volt batteries connected in series wherein 12-volt loads can be connected across the terminals of a single 12-volt battery while 24-volt loads can be connected across the series combination of both batteries. A single alternator is used to recharge the entire system, however, no single battery can be continuously charged by the alternator to maintain a constant voltage. Moreover, load requirements can drain one battery more rapidly than another without complex electronics to control and balance the loads.

Still other multiple voltage power supply systems use two 12-volt batteries connected in series for providing power to both 12-volt and 24-volt loads. In this instance, a single alternator is utilized having electrically isolated, multiple-phase, stator windings which feed full wave rectifiers for each battery to continuously supply power to selected voltage level outputs and the corresponding batteries. However, the multiple-phase windings share a common magnetic field resulting in an equal amount of current being induced in each phase winding. Therefore, this system has its disadvantages with unbalanced loads and may require complicated electronics to balance the system.

### SUMMARY OF THE INVENTION

Accordingly, it is an aspect according to the present invention to provide a multiple voltage battery power supply system for operating a plurality of electrical loads at selected voltage output levels.

It is a further aspect according to the present invention to provide a multiple voltage battery power supply system for maintaining continuous power to each battery and battery output, while continuously monitoring each battery independently to provide constant battery voltage.

It is still a further aspect according to the present invention to provide a multiple voltages DC electric power supply system that utilizes separate alternators for each battery in the system, wherein each alternator is electrically isolated from a common ground.

Accordingly, a multiple voltages DC electric power supply system for vehicle devices having multiple electrical load requirements of different voltages is provided. The system includes at least two electrical blocks connected in series. Each individual block comprises a set of output terminals and a battery having a required voltage which defines the block voltage. Within the block, the battery is connected in parallel with an alternator and a voltage regulator. Optionally, an alternate DC electrical power source can be connected in parallel with the battery, instead of or in addition to, the alternator. The alternator in each block comprises a series of power windings which feed a full wave rectifier to convert alternating current into direct current. Moreover, the alternator in each block contains a field winding. The voltage regulator monitors the block voltage and adjusts the voltage on the field winding accordingly such that the alternator maintains a specified output voltage level. Only one output terminal of only one block not connected to other blocks with both terminals can be connected to the system ground. In case the system utilize negative pole ground, the said block grounding can be executed through the alternator with negative pole designed connected to the alternator body connected to the ground (regular alternator). In case the system utilize positive pole ground, the said block grounding can be executed through the alternator with positive pole designed connected to the alternator body connected to the ground. The output terminals of each block alternator are electrically isolated to prevent the common ground of each individual block alternator from shorting out the remainder of the at least one electrical block.

The above aspects and other aspects, features, and advantages of the present invention are readily apparent from the following detailed description of the best mode for carrying out the invention when taken in connection with the accompanying drawings wherein like reference numbers correspond to like components.

### BRIEF DESCRIPTION OF THE DRAWINGS

FIG. 1 is a schematic view of a multiple voltages DC electric power supply system according to a preferred embodiment of the present invention;

FIG. 2 is a partial section view of an alternator according to a certain embodiment of the present invention;

FIG. 3 is a schematic view of a multiple voltages DC electric power supply system according to an alternate embodiment of the present invention; and

FIG. 4 is a schematic view of a multiple voltages DC electric power supply system according to another alternate embodiment of the present invention.

### DETAILED DESCRIPTION OF THE PREFERRED EMBODIMENT(S)

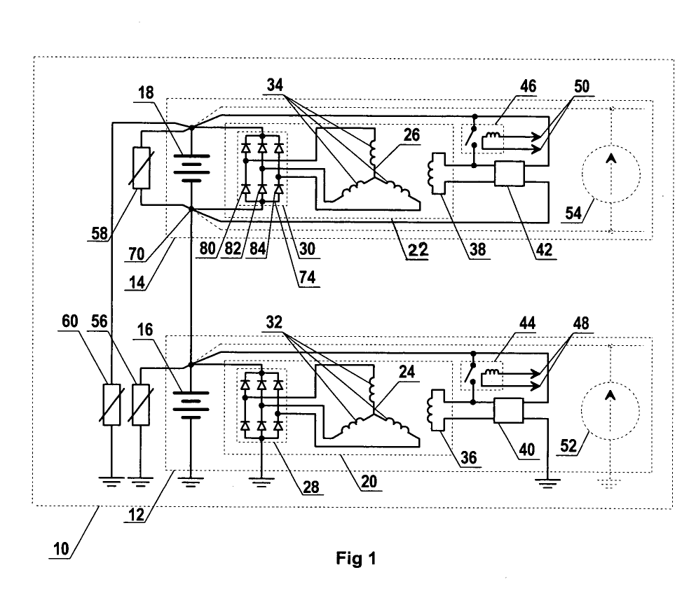

FIG. 1 illustrates a schematic view of a multiple voltages DC electric power supply system 10 suitable for powering vehicular devices having electrical loads requirements of differing voltages in accordance with a preferred embodiment of the present invention.

The system 10 in FIG. 1 is comprised of a first block 12 connected in series with a substantially electrically similar second block 14. Each block 12 and 14 contains a battery 16, 18, which is connected in parallel with an alternator 20, 22, respectively. The batteries 16, 18 can be standard 12-volt vehicle batteries, or rather, they can be any type of battery having a different voltage. As non-limiting examples, batteries 16, 18 can be a 3-volt, 6-volt, 9-volt, or even 24-volt battery. Moreover, each battery 16 and 18 are not required to have the same voltage. That is, battery 16 can maintain a voltage which differs from battery 18. For example, battery 16 can be a 12-volt battery, while battery 18 can be a 6-volt battery.

Preferably, the alternators 20, 22 each comprise of a three-phase alternating current generator 24, 26 coupled to a full wave rectifier 28, 30, respectively. Each three-phase generator 24, 26 further comprises power windings 32, 34 affixed to a stator (not shown) and field windings 36, 38 affixed to a rotor (not shown). The power windings 32, 34 are electrically connected to the full wave rectifiers 28, 30, respectively.

Each power block 12, 14 further comprises a voltage regulator 40, 42 also connected in parallel with batteries 16, 18 and alternators 20, 22, respectively. Moreover, each voltage regulator 40, 42 is electrically coupled to the field winding 36, 38 and a relay 44, 46. Each relay 44, 46 is normally open preventing current from being supplied to the field winding 36, 38. Each relay 44, 46 is also connected to a suitable electric power source, such as the ignition switch, through leads 48, 50. Accordingly, when the ignition switch is in the OFF position, the relay contact remains open and no current is supplied to the field windings 36, 38. Correspondingly, when the ignition switch is turned ON, each relay 44, 46 is energized closing the normally open contacts, which in turn provides current from each battery 16, 18 to the field winding 36, 38, respectively. The current in each field winding 36, 38 generates an electric field which induces current in the power windings 32, 34. The current in the power windings 32, 34 is passed through the rectifiers 28, 30 and distributed to vehicular electrical loads.

Each voltage regulator 40, 42 monitors the corresponding voltage of each battery 16, 18 and adjusts the current in each field winding 36, 38, accordingly. Under normal load conditions, sufficient current is supplied to the field windings 36, 38 in order to continuously charge each battery 16, 18 such that each battery maintains their rated voltage level (e.g., 13.6 volts for a 12-volt battery). Should the output power requirements increase, thereby lowering the voltage, increasing the drain on each battery, the voltage regulator increases the voltage and current supplied to the field windings. As a result, each alternator 20, 22 charges keep each batteries 16, 18 on charge and provides required output power. The net result is that a virtually constant voltage is maintained at each battery 16, 18 regardless of the output power requirements (except severe overloading).

It is important to note that each voltage regulator 40, 42 monitors each corresponding batteries 16, 18 terminals independently. That is, each voltage regulator dictates the current in the corresponding field winding, and ultimately the rectified power supplied to the corresponding battery and parallel electrical loads. Therefore, each battery can drain at different rates without interfering with the overall power supplied by system 10 through each block 12 and 14, or series combination thereof. Thus, each block 12, 14 is a self sufficient, independent source of power that when connected in series can provide even greater power (voltage) and the currents consumed by the electrical loads fed by the series blocks voltages are felt by the each block like an additional parallel electrical load on the block output terminals.

It is fully contemplated that each block 12, 14 can contain an alternate DC power source 52, 54 instead of the alternator 20, 22. The alternate power source 52, 54 is connected in parallel with the corresponding battery 12, 14 rated for the same voltage. As non-limiting examples, the alternate power source 52, 54 can be an additional battery, an alternator, a DC generator, a fuel cell, or the like. Moreover, the alternate power source 52, 54 can be added in parallel, in addition to the alternator 20, 22, to help meet power requirements of the electrical loads.

The system 10 further comprises three alternating vehicular electrical loads 56, 58, 60. The alternating loads 56, 58, 60 can be vehicle accessories such as lights, electric seats, car audio, or the like. Alternating load 56 is fed by the voltage supplied by block 12, while alternating load 58 is fed by the voltage supplied by block 14. Alternating load 60 is fed by the sum of the voltages supplied by blocks 12 and 14. The three varying loads are represented as alternating loads because it is contemplated that additional loads, in excess of the three shown and described, can be powered by each individual block 12 and 14, or sum thereof.

Accordingly, each individual block 12 and 14 is an independent, self-maintained battery power supply subsystem capable of operating individual vehicular loads which have voltage requirements commensurate with the output voltage of each block. Moreover, the cascading of block 12 and 14 together in series provides system 10 with the ability to supply adequate voltage to vehicle electrical loads having higher voltage requirements. Accordingly, system 10 described herein provides for greater power versatility than traditional single voltage/single alternator systems.

In a preferred embodiment, the voltage of battery 16 of block 12 and the voltage of battery 18 of block 14 is the same. For example, each battery 16, 18 can be 12-volts. Accordingly, certain accessories or devices having 12-volt voltage requirements may be connected to either block 12 or block 14 as loads 56 or 58, respectively. Moreover, certain vehicle devices and accessories may require much higher voltage, for example, 24-volts, to be fully operable. These such devices can be connected at across blocks 12 and 14 as represented by load 60. The result is that 24-volts is supplied to load 60. Each individual alternator 20, 22 in each corresponding block 12, 14 individually maintains constant battery charge. The result is a constant output voltage across block 12, block 14, and the series combination of both block 12 and block 14.

In an alternate embodiment, the voltage of battery 16 of block 12 differs from the voltage of battery 18 of block 14. For example, battery 16 can be 12-volts, while battery 18 can be 24-volts. Accordingly, vehicular loads having as many as three different voltage requirements can be operable by system 10. Block 12 can operate 12-volt loads, while block 14 can operate 24-volt loads. Moreover, the series combination of block 12 and block 14 can feed loads requiring 36 volts.

An important feature of the present invention is that the negative output terminal 70 of block 14 must be electrically isolated from the alternator body to maintain proper function. This isolation prevents block 14 from shorting out block 12 to a common ground when connected in series. For example, typical vehicle alternators have an isolated positive plate (diods radiator) connected to the isolated positive output terminal and a non-isolated plate (diods radiator) affixed to the alternator body, a conductor in order to save on not building the terminal. In turn, the alternator body is mounted directly to the engine (i.e. essentially vehicle ground). If an additional alternator is added in series, but is of the same regular design and construction of the first alternator, then special care must be taken to ensure that the traditionally non-isolated terminal of the second alternator is electrically isolated from the engine. Otherwise, the first alternator would effectively be shorted out.

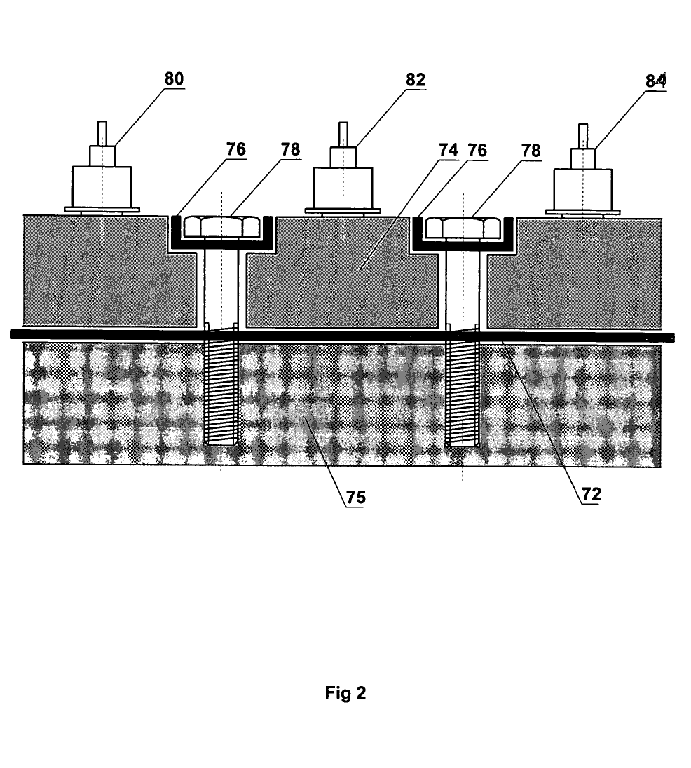

In a certain embodiment, best shown in FIG. 2, the isolation of the negative output terminal 70 of block 14 can be accomplished by placing an insulating sheet 72 between negative plate (diods radiator) 74 of the rectifier 30 and the alternator body 75. The insulating sheet 72 is preferably a high temperature, non-conducting plastic sheet. The negative plate (diods radiator) 74 of the rectifier 30 is a conductor on which three diodes 80, 82, 84 are physically and electrically connected. Typically, the negative plate 74 is formed from aluminum to provide an aspect of cooling to the alternator 22. However, it is fully contemplated that other conductive materials are usable. Further, insulating washers 76 are provided to electrically insulate each bolt 78 used to mount the negative plate (diods radiator) 74 to the alternator body 75. This arrangement will effectively isolate the rectifier 30 from the common ground alternator body 75 preventing block 14 from shorting block 12. In this case the wire providing the contact with the block circuit is connected directly to the plate (diods radiator) 74.

In an alternate embodiment, the alternators 20, 22 would vary from standard alternators in that they would be designed such that both output terminals are already electrically isolated from the alternator body. To provide the ground one would place a conductor between the negative output terminal of block 12 and the any sufficiently grounded convenient vehicle part. The advantages of modified alternators having this design will be better appreciated in systems having greater than two blocks, as described below.

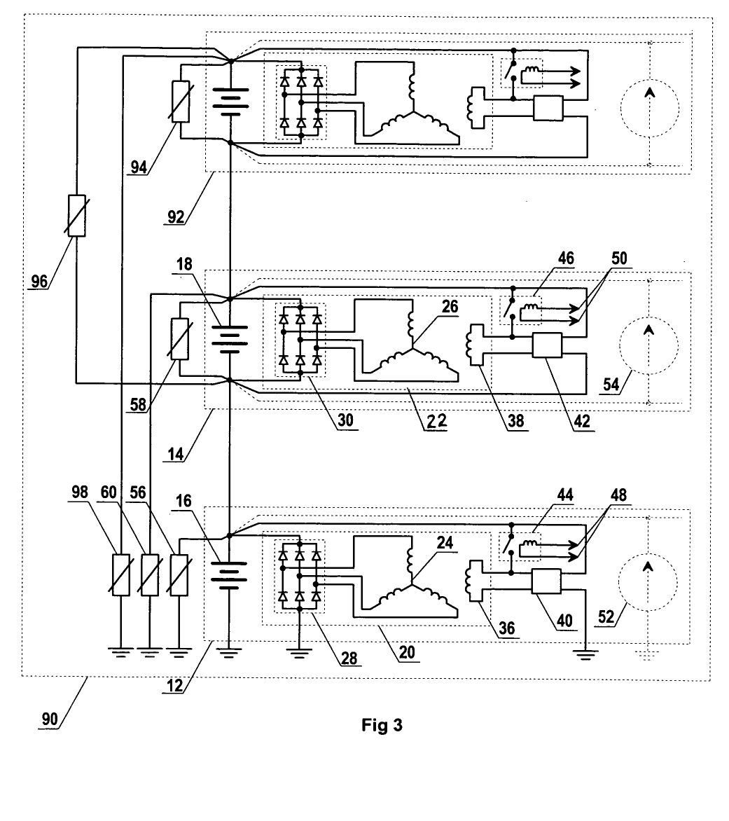

Referring now to FIG. 3, an alternate embodiment of the multiple voltage battery power supply system 90 is shown. Please note that similar elements retain the same reference numbers, while new elements are assigned new reference numbers. In particular, a third block 92 has been added and connected in series with blocks 12 and 14 to comprise the system 90. Again, block 92 is essentially electrically identical to blocks 12 and 14. In this arrangement, three additional alternating loads 94, 96, 98 may be powered by system 90. Alternating loads 56, 58, 60 remain electrically coupled to the blocks 12 and 14, or combination thereof, while alternating loads 94, 96, 98 can be connected to block 92 or across a combination of blocks 12, 14, and 92, as shown in FIG. 3.

Again, it is fully contemplated that each block 12, 14, or 92 can supply equivalent voltages, or rather, each block can maintain different voltages. In the former, as many as three alternating loads having different voltage requirements can be operated by system 90. With respect to the latter, as many as six alternating loads having different voltage requirements can be operated by the system 90. This allows for a multitude of accessories having different voltage requirements to be simultaneously operated by system 90.

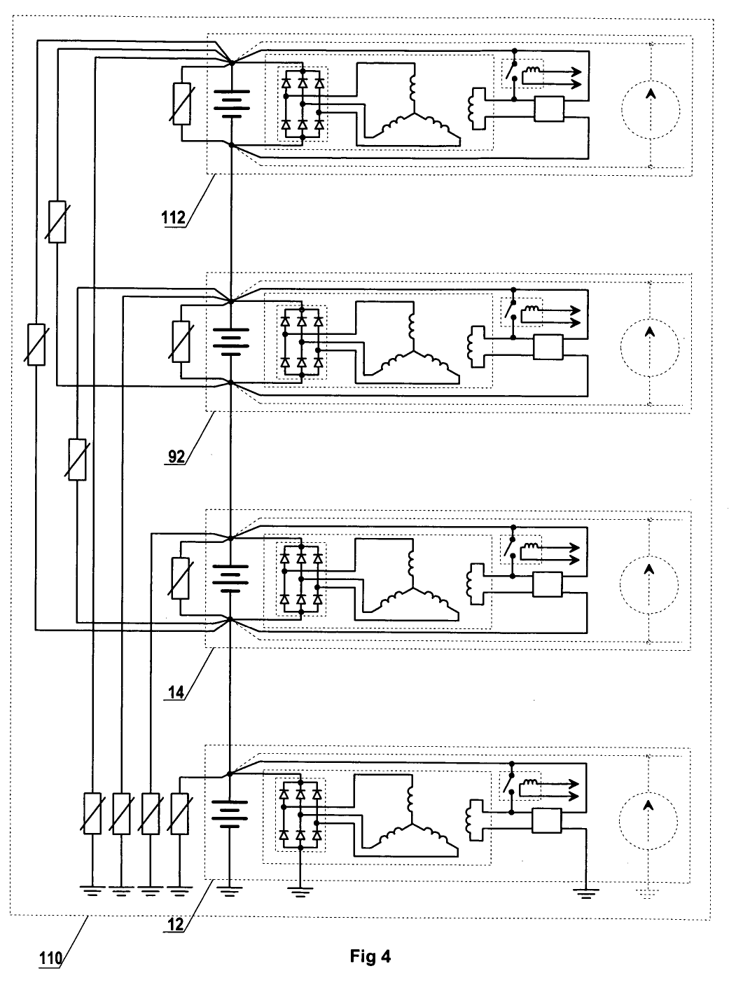

It is fully contemplated that an indefinite number of electrical blocks can be connected in series together, so long as the negative output terminals remain electrically isolated to prevent the short-circuit condition of the other blocks to a common ground. With regard to FIG. 4, a system 110 in accordance with yet another alternate embodiment of the present invention is illustrated. A fourth block 112 has been added to system 110 to provide as many as 10 different output voltages for various alternating loads. There is no limit to the number of electrical blocks that can be added to the system. The only limit is to the cost and space available for system 110 and safe voltage level.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A multiple voltage battery power supply system for operating a plurality of vehicle electrical loads at selected voltage output levels, the system comprising:
a first power block providing a first voltage output for operating vehicle electrical loads at a first voltage level;
a second power block connected in series with the first power block and substantially electrically similar to the first power block, the second power block providing a second voltage output independent from the first voltage output for operating vehicle electrical loads at a second voltage level;
wherein each power block independently maintains a substantially constant voltage at each corresponding voltage output and the series combination of each power block maintains a substantially constant third voltage output across both the first and second power blocks for operating vehicle loads at a third voltage level.

2. The system according to claim 1 further comprising at least one additional power block connected in series with the second power block and substantially electrically similar to the second power block, the at least one additional power block providing at least one additional independent constant voltage output enabling the system to operate vehicle electrical loads at at least three additional voltage levels.

3. The system according to claim 1, wherein the first voltage output is equal in value to the second voltage output.

4. The system according to claim 1, wherein the first voltage output differs in value from the second voltage output.

5. The system according to claim 2, wherein the at least one additional voltage output is equal in value to either the first or second voltage output, or both.

6. The system according to claim 2, wherein the at least one additional voltage output differs in value from either the first or second voltage output, or both.

7. The system according to claim 1, wherein each block comprises at least one battery electrically coupled in parallel with at least one alternator and a voltage regulator.

8. The system according to claim 7, wherein each alternator comprises a three-phase alternating current generator and a full wave rectifier, the three-phase alternating current generator having power windings and field windings, the power windings being coupled to the full wave rectifier and the field windings being coupled to the voltage regulator such that the voltage regulator monitors the corresponding voltage of each battery and adjusts the voltage and current correspondently in each field winding accordingly so that the alternator continuously charges each battery allowing each battery to maintain its rated voltage and provides required power to the vehicle electrical loads.

9. The system according to claim 1, where in virtually any required DC multiple voltages electric power supply system, consisted of the connected in series blocks, where each block contains required block voltage and power connected in parallel DC electric power generating and accumulating sources or at least one battery and at least one DC generator (alternator) with isolated from its body positive and negative output terminals and voltage regulator powered from the block voltage and feeding the DC generator (alternator) field winding maintaining the required block voltage, with the electrical loads connected in circuits to any single block or to any series of said blocks or both, with only one grounded output pole (terminal) of only one of two blocks not connected to other blocks with both output poles (terminals), in case negative pole is required to be grounded the said block can comprise regular DC generator (alternator) with negative pole grounded to the alternator body providing the block grounding.
